(19) United States
(12) Patent Application Publication
(10) Pub. No.: US 2009/0161012 A1
(43) Pub. Date: Jun. 25, 2009

(54) Dynamic multilayer video processing method

(75) Inventors: Su-Woan Chow, Taipei (TW); Ching-San Hsu, Taipei (TW); Chie-Jin Cheng, Taipei (TW); Pong-Sheng Wang, Taipei (TW); Chiung-Yueh Chang, Taipei (TW); Quxiang Fang, Sunnyvale, CA (US)

Correspondence Address: BACON & THOMAS, PLLC, 625 SLATERS LANE, FOURTH FLOOR, ALEXANDRIA, VA, 22314-1176, US

(73) Assignee: NSTREAMS TECHNOLOGIES, INC., Taipei (TW)

(21) Appl. No.: 12/000,949

(22) Filed: Dec. 19, 2007

(51) Int. Cl. H04N 7/00

(52) U.S. Cl. 348/468; 348/E07.001

(57) ABSTRACT

In a dynamic multilayer video processing method applied to a signal receiving apparatus, the signal receiving apparatus is connected to a display device. To display a screen on the display device, the method transmits a request signal to a system control end connected to the signal receiving apparatus for receiving a video signal and a graphic/text data, and processes and divides the video signal and the graphic/text data into a video image layer and a graphic/text data image layer, and then displays a dynamic multilayer menu on the display device for users to select the required displayed image, and finally displays an image layer specified by a select instruction on the display device according to at least one select instruction received by the signal receiving apparatus, so that the contents of the TV video, graphic/text data or OSD information on the display panel can be processed, displayed or modified;

### FIELD OF THE INVENTION

The present invention relates to a video processing method, and more particularly to a dynamic multilayer video processing method for receiving a video signal and a graphic/text data, and displaying images selected by users through a dynamic multilayer menu on a display device.

### BACKGROUND OF THE INVENTION

Traditional display devices including cathode ray tube (CRT) display devices and liquid crystal display (LCD) display devices usually come with a large volume and consume much power, and they cannot satisfy user's actual needs of portability, transportation and installation and these display devices are eliminated gradually from the market. Since flat panel display technology advances and high-tech video products, such as an LCD device, tend to be thinner, lighter, shorter and smaller in recent years, the LCD device has the advantages of low power, small volume, zero radiation and light weight, therefore LCD devices become popular and welcome by consumers, and the demand, market share and application of LCD display devices are growing and expanding increasingly. In addition, the cost of LCD panels keeps decreasing, so that LCD display devices replace CRT display devices and become popular and welcome by consumers gradually.

As digital TVs are being tested and broadcasted in countries all over the world, LCD TVs with a function of concurrently receiving analog TV signals and digital TV signals become a mainstream product in the TV market, and consumers are fond of the diversified functions provided by the LCD TVs, and thus the market share of LCD TVs rises drastically in recent years, and major manufacturers devote all effort on the research for innovative technology and improvement of LCD TVs and invest substantially on the LCD TV production. Therefore, the quality, color, viewing angle and many other add-on functions of the LCD TVs are modified and improved tremendously. Before a screen is formed on the LCD TV, the technology related to the control and processing of encoding/decoding, specification, quality and color are added and improved, so that the display screen of the LCD TV has reached high resolution and drawn much attention from consumers.

Since present digital TV broadcasting systems process digitized voice, image and text signals, and their signal processing technology is unlike the TV broadcasting system in the past. To make the operation of digital TV broadcasting more stable, a video compression standard was established because a large storage space is required for accessing digital data and a broad bandwidth for transmitting digital videos. Therefore, a general standard, motion picture experts group (MPEG-2), was established to save the space required for storing digital videos while maintaining the same quality of the digital videos as that before compression and a low cost, and reassembling the compressed data within a very short time.

In general, a core audio/video compression technology adopted by present digital multifunctional CDs or digital TV systems are of MPEG-2 standard regardless of their playback or broadcast via cable or satellite, and thus it is necessary to encode/decode digital videos according to the MPEG-2 standard when the digital LCD TV plays digital videos. Since the contents of general digital videos are generally TV videos, it is necessary to overlap the text and menu on the TV video in advance, and then create a MPEG-2 file before we can display information such as text or menu on the TV video. After the digital LCD TV receives the MPEG-2 file, the file is decoded by the MPEG-2 standard to display a TV video on the digital LCD TV, and the TV video shows the previously created text or menu.

However, the practical use of the traditional method of creating MPEG-2 files is very inconvenient, and its causes and derived shortcomings are described as follows:
1. If it is necessary to display information such as text or menu on a TV video, the text and menu must be overlapped on the TV video first, and then a MPEG-2 file is created. In such arrangement, the aforementioned processes must be completed before performing the broadcast, or else the MPEG-2 file cannot be played at a predetermined time.
2. If it is necessary to modify the overlapped text and menu on the TV video before a predetermined time, the MPEG-2 file must be created again, so as to overlap the modified text or menu on the TV video. Such arrangement not only processes a larger volume of data, but also takes a longer production time.
3. Since the information such as text or menu is overlapped on the TV video, therefore we cannot modify the contents when the MPEG-2 file is broadcasted at a predetermined time.
4. If the MPEG-2 file is played at a predetermined time, we cannot timely display the current time on the TV video or add information to the TV video.

Therefore, solving the foregoing problems, reducing the time for creating MPEG-2 files and the cost can provide more flexibility on processing TV video, text or menu and better user-friendliness to digital broadcasting to gain an advantageous market position in the severe competition.

### SUMMARY OF THE INVENTION

In view of the foregoing shortcomings of the prior art, the inventor of the present invention based on years of experience in the related industry to conduct extensive researches and experiments, and finally invented a dynamic multilayer video processing method to overcome the shortcomings of the prior art.

It is a primary objective of the present invention to provide a dynamic multilayer video processing method, and the method is applied to a signal receiving apparatus, and the signal receiving apparatus is connected to a display device. In the process of displaying a screen on the display device, the method transmits a request signal to a system control end connected to the signal receiving apparatus for receiving a video signal and a graphic/text data, and processes and divides the video signal and the graphic/text data into a video image layer and a graphic/text data image layer, and then displays a dynamic multilayer menu on the display device for users to select the required displayed image, and finally displays an image layer specified by a select instruction on the display device according to at least one select instruction received by the signal receiving apparatus, so that the contents of the TV video, graphic/text data or OSD information on the display panel can be processed, displayed or modified.

To make it easier for our examiner to understand the objective, technical characteristics and effects of the present invention, preferred embodiments will be described with accompanying drawings as follows;

### BRIEF DESCRIPTION OF THE DRAWINGS

FIG. 1 is a schematic view of transmitting signals in accordance with the present invention;

FIG. 2 is a flow chart of a dynamic multilayer video processing method of the present invention; and

FIG. 3 is a schematic view of a dynamic multilayer menu of the present invention.

### DETAILED DESCRIPTION OF THE PREFERRED EMBODIMENTS

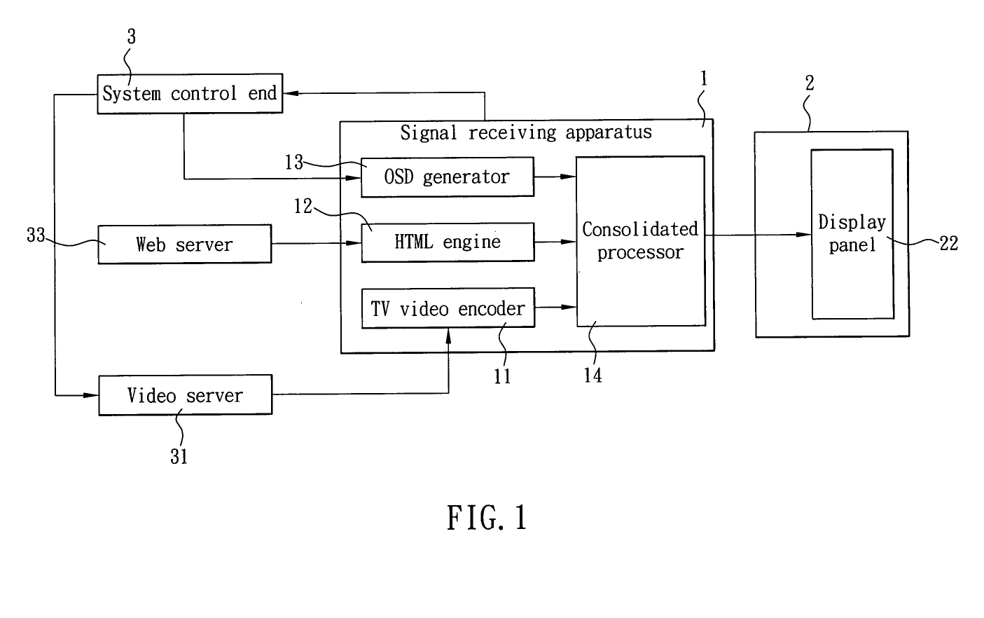

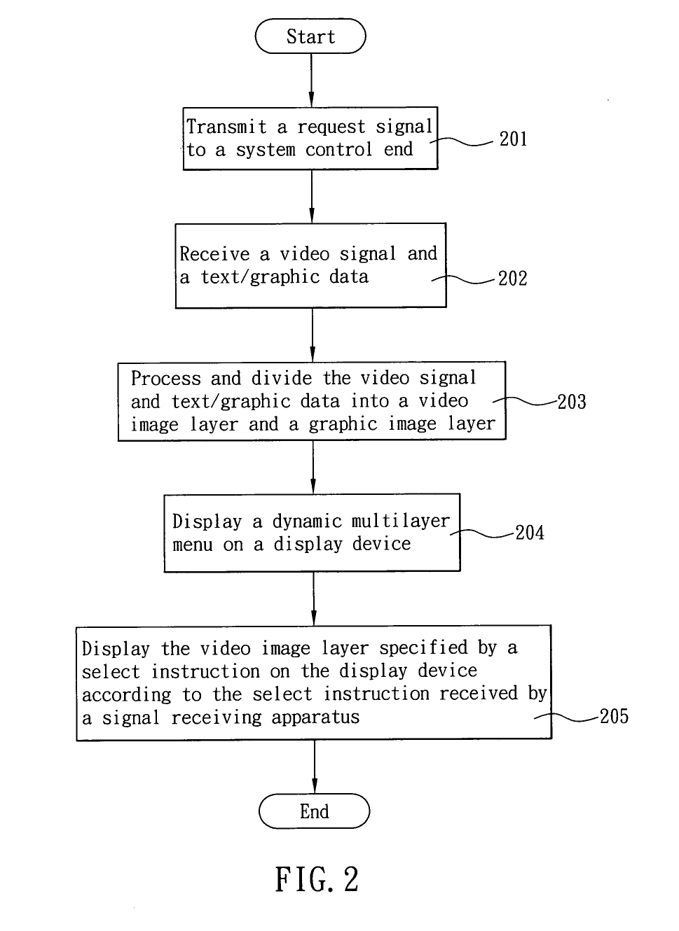

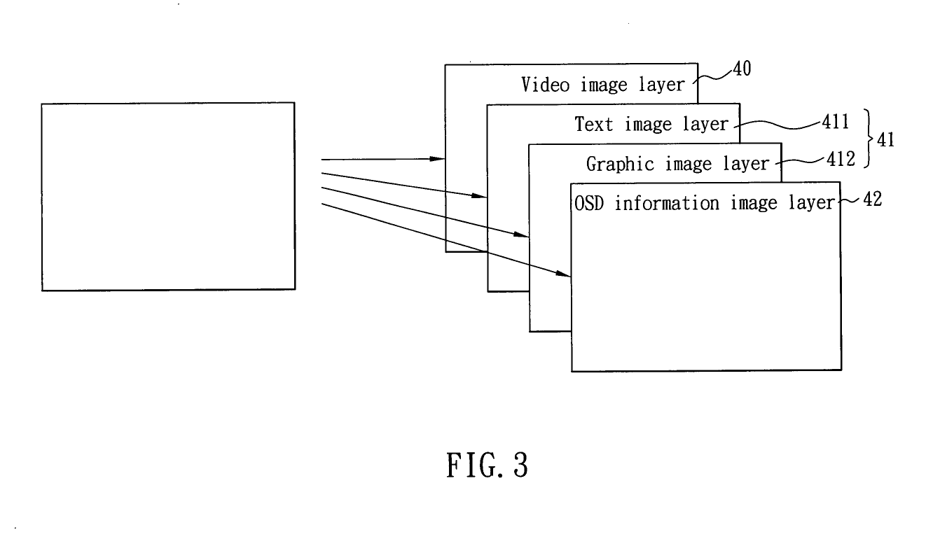

Referring to FIG. 1 for a dynamic multilayer video processing method of the present invention, the method is applied to a signal receiving apparatus 1, and the signal receiving apparatus 1 can be a digital set-top box (STB) connected to a display device 2 (such as a television) for processing TV video, text, graphic or on screen display (OSD) information, so that the TV video, text, graphic or OSD information can be processed more flexibly, and a dynamic multilayer menu can be created on a displayed screen of the display device 2, so that the contents of the text or menu can be modified timely while the TV video is being played, or information can be added to the TV video, so as to overcome the foregoing shortcomings of the prior art, greatly enhance the flexibility of creating TV videos, and reduce the production time and cost. The method of the invention comprises the following steps as shown in FIG. 2 when the display device 2 displays a screen:
(201) Transmit a request signal to a system control end 3 connected to the signal receiving apparatus 1. Referring to FIG. 1 for the present invention, the signal receiving apparatus 1 is connected to the system control end 3, and the system control end 3 is connected to a video server 31 and a web server 33. After the request signal is transmitted to the system control end 3, the system control end 3 will transmit a control instruction to the video server and the web server 33.
(202) Receive a video signal and a graphic/text data. Referring to FIG. 1 for the invention, the signal receiving apparatus 1 comprises a TV video encoder 11 and a HTML engine 12, wherein the video signal is transmitted from the video server 31 to the TV video encoder 11, and the graphic/text data is transmitted from the web server 33 to the HTML engine 12.
(203) Process and divide the video signal and graphic/text data into a video image layer 40 and a graphic/text data image layer 41. Referring to FIGS. 1 and 3 for a preferred embodiment of the present invention, the video image layer 40 is produced by the video signal received from the TV video encoder 11, and the graphic/text data comprises a text data and a graphic file, and the graphic/text data image layer 41 comprises a text image layer 411 and a graphic image layer 412, wherein if the HTML engine 12 receives the text data, the HTML engine 12 will carry out a video processing to the text data according to a hypertext markup language (HTML), so that the content can be displayed according to the setup of the text data, and the text data is processed into the text image layer 411. If the HTML engine 12 receives the graphic file, the HTML engine 12 will carry out a video processing to the graphic file according to the HTML, so that the content can be displayed according to the setup of the graphic file, and the graphic file is processed into the graphic image layer 412. Therefore, the HTML engine 12 can display the text data or the graphic file at an appropriate displayed position according to the HTML.
(204) Display a dynamic multilayer menu on the display device 2. Referring to FIGS. 1 and 3 for a preferred embodiment of the present invention, the signal receiving apparatus 1 further comprises an OSD generator 13, and after the video signal and the graphic/text data are received and before the dynamic multilayer menu is displayed, the signal receiving apparatus 1 receives an OSD information, and the OSD generator 13 processes the OSD information into an OSD information image layer 42, so that the video image layer 40, the text image layer 411, the graphic image layer 412, and the OSD information image layer 42 can be processed independently, so as to overcome the shortcomings of a traditional way of producing TV videos and greatly improve the flexibility of producing TV videos. Further, when the method displays the dynamic multilayer menu on the display device 2, a video image option, a text image option, a graphic image option and an OSD information image option are displayed in the dynamic multilayer menu and provided for users to select all or one or more of the video image layer 40, the text image layer 411, the graphic image layer 412, and the OSD information image layer for the display on the display device 2.
(205) Display an image layer specified by a select instruction on the display device 2 according to at least one select instruction received by the signal receiving apparatus 1.

In a preferred embodiment of the present invention as shown in FIG. 1, the signal receiving apparatus 1 further comprises a consolidated processor 14 connected to the HTML engine 12, the TV video encoder 11 and the OSD generator 13, such that when the method displays an image layer specified by the select instruction on the display device 2, the consolidated processor 14 receives the image layer specified by the select instruction, and processes and combines each image layer into an output video according to the layer and sequence of the display, and then transmits the output video to the display device 2, so that the display device 2 can display the output video on a display panel 22 (such as a display panel of a flat panel TV) of the display device 2 according to the display format of the display device 2.

The video signal, the text data, the graphic file and the OSD information are received separately and then processed layer by layer. In other words, different text data, graphic files or OSD information are received continuously when the display panel 22 displays the TV videos, and the dynamic multilayer menu is provided for users to select the desired information or image with a variety of expressions for the display. For instance, when the display screen shows a menu of a sport program timetable, the TV videos can be changed into game movies or when the TV videos shown in the display screen are cartoons, then the menu displayed on the screen can be changed to a cartoon program timetable, so as to greatly enhance the flexibility of producing TV videos, texts, menus or graphics.

The dynamic multilayer video processing method in accordance with the present invention can achieve the following purposes and effects:
1. The contents of video image layer 40, the text image layer 411, the graphic image layer 412 and the OSD information image layer 42 can be changed freely or covered by another image layer without the need of modifying each image layer, and thus greatly reducing the operating time and cost.
2. The text image layer 411 can be used for displaying the current time or add other information as well as providing special effects such as fade-in and fade-out or display in semi-transparency or opacity. Further, the text data may come from a text file or a database.
3. The graphic image layer 412 can display pictures in different formats, making the menu or information produced by the text image layer 411 look like a well-designed webpage, and greatly enhancing the artistic look.
4. Image layers do not come with a fixed sequence, and the sequence can be changed freely according to their characteristics, not simply providing more flexibility to the design of a display screen, but also showing more changes and combinations of the display screens.
5. Other information can be displayed on the OSD information image layer 42, and the OSD information image layer 42 also has the capability of displaying a database and a specific wording.
6. Although another prior art for displaying HTML pages can display time or text on a TV video instantly, such prior art does not allow any overlapped text and TV video. In other words, the background of the text cannot be TV video, and the TV video cannot be covered by text. With the present invention, the shortcomings of the prior art can be overcome.

While the invention has been described by means of specific embodiments, numerous modifications and variations could be made thereto by those skilled in the art without departing from the scope and spirit of the invention set forth in the claims.

What is claimed is:

1. A dynamic multilayer video processing method, applied to a signal receiving apparatus that is connected to a display device and, during displaying a screen on the display device, the method comprising the steps of:
transmitting a request signal to a system control end connected to the signal receiving apparatus;
receiving a video signal and a graphic/text data from the system control end;
processing and dividing the video signal and the graphic/text data into a video image layer and a graphic/text data image layer;
displaying a dynamic multilayer menu on the display device; and
displaying the image layer specified by at least one select instruction on the display device, wherein the select instruction received by the signal receiving apparatus is selected by user through the dynamic multilayer menu.

2. The dynamic multilayer video processing method as recited in claim 1, wherein after the video signal and the graphic/text data are received by the signal receiving apparatus, and before the dynamic multilayer menu is displayed on the display device, the method further comprises the steps of:
receiving OSD (on screen display) information; and
processing and dividing the OSD information into an OSD information image layer.

3. The dynamic multilayer video processing method as recited in claim 2, wherein the graphic/text data comprises a text data, and when a HTML engine in the signal receiving apparatus receives the text data, the method processes and divides the text data into a text image layer according to the HTML.

4. The dynamic multilayer video processing method as recited in claim 2, wherein the graphic/text data comprises a graphic file, and when a HTML engine in the signal receiving apparatus receives the graphic file, the method processes and divides the graphic file into a graphic image layer according to the HTML.

5. The dynamic multilayer video processing method as recited in claim 3, wherein when an image layer specified by the select instruction is displayed on the display device, the method comprises the steps of:
a consolidated processor in the signal receiving apparatus receiving the image layer specified by the select instruction;
the consolidated processor consolidating and processing each image layer into an output video according to the layer and display sequence of the image layers;
transmitting the output video to the display device; and
the display device carrying out a development process to the output video according to its display format, and then outputting the output video on the display device.

6. The dynamic multilayer video processing method as recited in claim 4, wherein when an image layer specified by the select instruction is displayed on the display device, the method comprises the steps of:
a consolidated processor in the signal receiving apparatus receiving the image layer specified by the select instruction;
the consolidated processor consolidating and processing each image layer into an output video according to the layer and display sequence of the image layers;
transmitting the output video to the display device; and
the display device carrying out a development process to the output video according to its display format, and then outputting the output video on the display device.

7. The dynamic multilayer video processing method as recited in claim 5, wherein the method displays a video image option, a text image option, a graphic image option and an OSD information image option on the dynamic multilayer menu, when the dynamic multilayer menu is displayed on the display device.

8. The dynamic multilayer video processing method as recited in claim 6, wherein the method displays a video image option, a text image option, a graphic image option and an OSD information image option on the dynamic multilayer menu, when the dynamic multilayer menu is displayed on the display device.

9. The dynamic multilayer video processing method as recited in claim 7, wherein the video image layer is produced by the video signal received by a TV video encoder in the signal receiving apparatus.

10. The dynamic multilayer video processing method as recited in claim 8, wherein the video image layer is produced by the video signal received by a TV video encoder in the signal receiving apparatus.

11. The dynamic multilayer video processing method as recited in claim 9, wherein the video signal is transmitted from a video server connected to the system control end to the signal receiving apparatus.

12. The dynamic multilayer video processing method as recited in claim 10, wherein the video signal is transmitted from a video server connected to the system control end to the signal receiving apparatus.

13. The dynamic multilayer video processing method as recited in claim 7, wherein the text data and graphic file is transmitted to the signal receiving apparatus by a web server connected to the system control end.

14. The dynamic multilayer video processing method as recited in claim 8, wherein the text data and graphic file is transmitted to the signal receiving apparatus by a web server connected to the system control end.

15. The dynamic multilayer video processing method as recited in claim 7, wherein the OSD information is generated by an OSD generator in the signal receiving apparatus.

16. The dynamic multilayer video processing method as recited in claim 8, wherein the OSD information is generated by an OSD generator in the signal receiving apparatus.
